(19) United States
(12) Patent Application Publication
(10) Pub. No.: US 2013/0041491 A1
(43) Pub. Date: Feb. 14, 2013

(54) COMMUNICATION SYSTEM AND COMMUNICATION METHOD

(71) Applicants: Kazunori Itoyanagi, Taito-ku (JP); Daisuke Enomoto, Tsukubamirai-shi (JP)

(72) Inventors: Kazunori Itoyanagi, Taito-ku (JP); Daisuke Enomoto, Tsukubamirai-shi (JP)

(21) Appl. No.: 13/261,377

(22) PCT Filed: Jan. 20, 2011
(86) PCT No.: PCT/JP11/51002

§ 371 Date: Sep. 14, 2012

(30) Foreign Application Priority Data
Jan. 22, 2010 (JP) 2010-012277
Apr. 9, 2010 (JP) 2010-090754

(51) Int. Cl. G06F 17/00

(52) U.S. Cl. 700/94

(57) ABSTRACT

In a communication system, a distributor terminal distributes content which is generated in real time to a content distribution unit, a request management server has an extracting unit which extracts an audio communication terminal to be connected from among a plurality of audio communication terminals and a connection location information transmitting unit which transmits connection location information with respect to an audio communication terminal which was extracted by the extracting unit, and an audio communication terminal receives connection location information which was transmitted from a request management server and is connected to an audio communication connection apparatus in accordance with connection location information and transmits audio information. A content server receives from the audio communication connection apparatus audio information which was transmitted to the audio communication connection apparatus from an audio communication terminal and distributes it to user terminals together with content.

### TECHNICAL FIELD

This invention relates to a communication system and a communication method which enables communication between users who are viewing content and a distributor when the content is distributed from the distributor to the users.

The present invention claims the priority of JP 2010-12277, filed in Japan on Jan. 22, 2010 and JP 2010-90754, filed in Japan on Apr. 9, 2010, the contents of which are incorporated by reference.

### BACKGROUND ART

An information and communication system is used such that an information and communication server which is connected to a plurality of user terminals through a network distributes comments, which are input to user terminals in response to moving picture information which is distributed to user terminals, to other user terminals. In such an information and communication system, a plurality of users who are simultaneously viewing the same moving pictures can send comments to each other in real time, so it is possible to provide a communication space having a sense of presence.

As technology for controlling the transmission and receipt of comments among a plurality of user terminals, Patent Document 1, for example, discloses an information and communication system in which comments transmitted from user terminals are managed by an information and communication server. Such an information and communication system is connected to a large number of user terminals and can be entered by many users. Even when a large number of user terminals are connected, the load on the information and communication server can be decreased according to such an information and communication system.

### PRIOR ART DOCUMENTS

### Patent Documents

Patent Document 1: JP H10-334021A

### SUMMARY OF THE INVENTION

### Technical Problem

In recent years, in addition to systems which distribute previously recorded moving pictures, systems are being provided which distribute as a unit of content, live videos, namely, which are captured with a camera and distributed in real time to user terminals as the above-described moving pictures. When distributing such content, entrants to the content are present in the content which is distributed in real time.

It is also conceivable to distribute in real time audio which is captured a microphone or the like together with previously recorded moving pictures. In this case, when distributing the content, entrants to the content are also present in the content which is distributed in real time.

In this manner, content which is being distributed is becoming diversified, so it is desirable to be able to provide a new communication space suitable for such content.

However, Patent Document 1 only lets users refer to comments with respect to moving pictures in text data each other for communication between user terminals. Accordingly, it was not always possible to carry out adequate communication concerning content distributed in real time in the above-described manner.

The present invention was made in light of such circumstances, and its object is to provide a communication system and a communication method which can provide a new communication space in which information other than text data can be utilized.

### Means for Solving the Problem

In order to solve the above-described problems, the present invention provides a communication system for distributing content from a content distribution unit to a plurality of user terminals and distributing to the plurality of user terminals comments which are transmitted from the user terminals in response to the content which was transmitted to the user terminals, wherein the communication system has a distributor terminal which distributes the content to the content distribution unit, a plurality of audio communication terminals, a request management server which comprises an extracting unit which extracts an audio communication terminal to which connection is to take place from the plurality of audio communication terminals and a connection location information transmitting unit which transmits connection location information which is different for each content to the audio communication terminal extracted by the extracting unit, and an audio communication connection apparatus which is connected to the extracted audio communication terminal based on the connection location information transmitted from the extracted audio communication terminal which makes communication possible between the extracted audio communication terminal, the content distribution unit, and the distributor terminal, wherein the content distribution unit distributes audio information transmitted to the audio communication connection apparatus from the extracted audio communication terminal to the user terminals together with the content, and the audio communication connection apparatus transmits the audio information to the distributor terminal.

In the communication system according to the present invention, the audio communication terminals are preferably cellular phones, and the connection location information is the telephone number of the audio communication connection apparatus.

In the communication system according to the present invention, the distributor terminal preferably distributes content which was generated in real time to the content distribution unit.

In the communication system according to the present invention, the audio communication terminal preferably comprises an audio communication request unit which transmits to the request management server an audio communication request to carry out audio communication concerning the content, the request management server preferably comprises a request receiving unit which receives an audio communication request transmitted from the audio communication request unit, and the extracting unit preferably extracts an audio communication terminal to which connection is to take place from among the audio communication terminals which made an audio communication request based on the audio communication request received by the request receiving unit.

In the communication system according to the present invention, the request management server preferably comprises a request list memory which associates user identification information which identifies users who are using the audio communication terminals with a priority which indicates the priority of extraction and stores them, and the extracting unit preferably extracts the audio communication terminal to be connected by extracting user identification information in accordance with the priority stored in the request list memory.

In the communication system according to the present invention, the request management server preferably comprises a list management unit which updates the priority stored in the request list memory when an instruction is received from any of the user terminals or the audio communication terminals or when extraction is carried out by the extracting unit.

In the communication system according to the present invention, the request list memory preferably newly stores user identification information transmitted from the audio communication terminal each time the request receiving unit receives the audio communication request transmitted from the audio communication receiving unit, and the list management unit preferably stores the priority corresponding to the user identified by the user identification information being associated with the newly stored user identification information in the request list memory.

In the communication system according to the present invention, the request management server comprises an attribute information memory which stores the attribute information for each of the users who are using the audio communication terminals, and the extracting unit may extract the audio communication terminal to be connected based on the attribute information stored in the attribute information memory.

In the communication system according to the present invention, the content distribution unit may distribute content to the user terminal corresponding to the attribute information to which content is to be distributed based on the attribute information which is stored in the request management server.

In the communication system according to the present invention, the extracting unit may extract an audio communication terminal to which connection is to take place at random from among the plurality of audio communication terminals.

In the communication system according to the present invention, the extracting unit may extract the audio communication terminal which is to be connected from among the plurality of audio communication terminals in accordance with the order in which an audio communication request was carried out.

In the communication system according to the present invention, the extracting unit may further extract the audio communication terminal which is to be connected from among the extracted audio communication terminals.

The present invention also provides a communication method in a communication system for distributing content from a content distributing unit to a plurality of user terminals and distributing to the plurality of user terminals comments which were transmitted from the user terminals in response to the content distributed to the user terminals, the communication method comprising distributing the content to the content distribution unit by a distributor terminal, extracting an audio communication terminal to which connection is to take place from the plurality of audio communication terminals by an extracting unit of a request management server, transmitting connection location information which is different for each content to the audio communication terminal extracted by the extracting unit by a connection location information transmitting unit of the request management server, receiving the connection location information transmitted from the request management server by the extracted audio communication terminal, connecting to an audio communication connection apparatus in accordance with the connection location information to transmit audio information by the extracted audio communication terminal, distributing audio information transmitted to the audio communication connection apparatus from the extracted audio communication terminal to the user terminals together with the content by the content distribution unit, and communicating the audio information between the audio communication terminal and the distributor terminal by the audio communication connection apparatus.

### Advantageous Effects of Invention

As explained above, according to the present invention, content which is distributed by a distributor terminal is distributed to user terminals, a request management server extracts audio communication terminals, connection location information is transmitted with respect to the extracted audio communication terminals, the audio communication terminals receive connection location information which was transmitted from the request management server, and they are connected to the audio communication connection apparatus in accordance with this connection location information and audio information is transmitted. Furthermore, the audio communication connection apparatus establishes communication between the audio communication terminal and the distributor terminal. As a result, when content can be distributed to the user terminal, conversation communication is established between a person using the audio communication terminal and a distributor using the distributor terminal, and the contents of the conversation can be distributed together with the content to the user terminal. As a result, the persons who are talking can have audio communication with the distributor of the content and can participate in the content, so a new communication space can be provided utilizing information other than text data.

In addition, a user of a user terminal can make comments on the content while viewing the content and can listen to conversations between the persons having the conversation and the distributor while viewing the content. It is also possible to add comments with respect to the conversation. Accordingly, when viewing content by utilizing a user terminal, it is possible to carry out communication by conversations with the participants of the content, whereby various types of communication can be carried out.

### BRIEF EXPLANATION OF THE DRAWINGS

FIG. 1 is a block diagram showing a communication system according to a first embodiment of the present invention.

FIG. 2 is block diagram showing the distributor terminal shown in FIG. 1.

FIG. 3 is a block diagram showing the content server shown in FIG. 1.

FIG. 4 is a block diagram showing the audio communication terminal shown in FIG. 1.

FIG. 5 is a block diagram showing the audio communication connection apparatus shown in FIG. 1.

FIG. 6 is a block diagram showing the request management server shown in FIG. 1.

FIG. 7 is a diagram showing an example of information which is stored in the request list memory shown in FIG. 1.

FIG. 8 is a diagram showing an example of information stored in the attribute information memory shown in FIG. 1.

FIG. 9 is a diagram showing an example of information stored in the distribution list memory shown in FIG. 1.

FIG. 10 is a sequence diagram showing the operation of the communication system shown in FIG. 1.

FIG. 11 is a diagram showing the flow of information in the communication system shown in FIG. 1.

FIG. 12 is a block diagram showing the flow of information in a communication system 1 in a second embodiment of the present invention.

FIG. 13 is a block diagram showing a communication system 1 in a third embodiment of the present invention.

FIG. 14 is a diagram showing a request management server in a fourth embodiment of the present invention.

FIG. 15 is a diagram showing an example of information stored in a request list memory in a fourth embodiment of the present invention.

FIG. 16 is flow chart showing the operation of the request management server in the fourth embodiment of the present invention.

### DESCRIPTION OF EMBODIMENTS

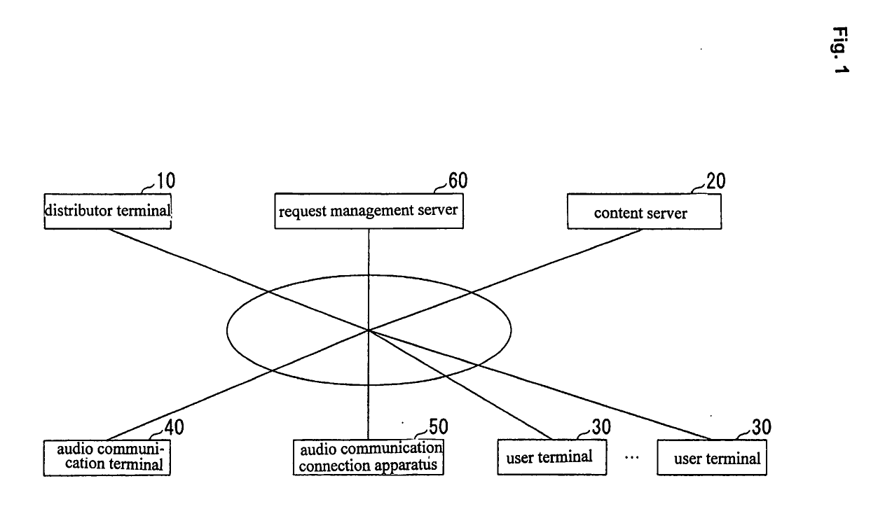

Below, a communication system according to an embodiment of the present invention will be explained while referring to the drawings. FIG. 1 is schematic block diagram showing the structure of a communication system according to a first embodiment of the present invention.

The communication system 1 comprises a distributor terminal 10, a content server 20, user terminals 30, audio communication terminals 40, an audio communication connection apparatus 50, and a request management server 60 which are connected with each other via a network. The network can be either an interne network or a public network, but the two types of network can also be used in combination.

In this communication system 1, the distributor terminal 10 distributes content including live pictures to the content server 20. The content server 20 distributes the content to user terminals 30. The content server 20 also receives comments which were input through user terminals 30 from users viewing the content and distributes the comments as content to other user terminals 30.

The request management server 60 establishes audio communication between a user terminal 30 of a user who is viewing the content or an audio communication terminal 40 of a user who is not viewing the content and the distributor terminal 10 by using the audio communication connection apparatus 50.

As a result, content including live pictures is distributed to the user terminals 30, and audio communication between a person using an audio communication terminal 40 and the distributor at the distributor terminal 10 is distributed from the content server 20 to the user terminals 30. In this manner, it is possible to converse with the distributor who participates in content which is being distributed in real time, and it is possible to participate in the content which is being distributed in real time. In addition, using a user terminal 30, it is possible to view content in which one is participating via telephone. A user of a user terminal 30 can append comments regarding content while viewing the content being distributed in real time, and he can listen to conversations with the distributor while viewing the content and can append comments thereto.

In this manner, by using an audio communication terminal 40 (such as a cellular phone), it is possible to converse with a distributor (such as a participant) who is distributing content containing live pictures, and in addition to communication by comments using a user terminal 30, a new communication space can be provided. As a result, while watching content using a user terminal 30, a user can not only enjoy sending and reading comments but can conduct communication by conversing with participants who participate in the live pictures. Accordingly, a user can carry out a wide variety of communication.

Next, the communication system 1 will be further explained referring to the drawings.

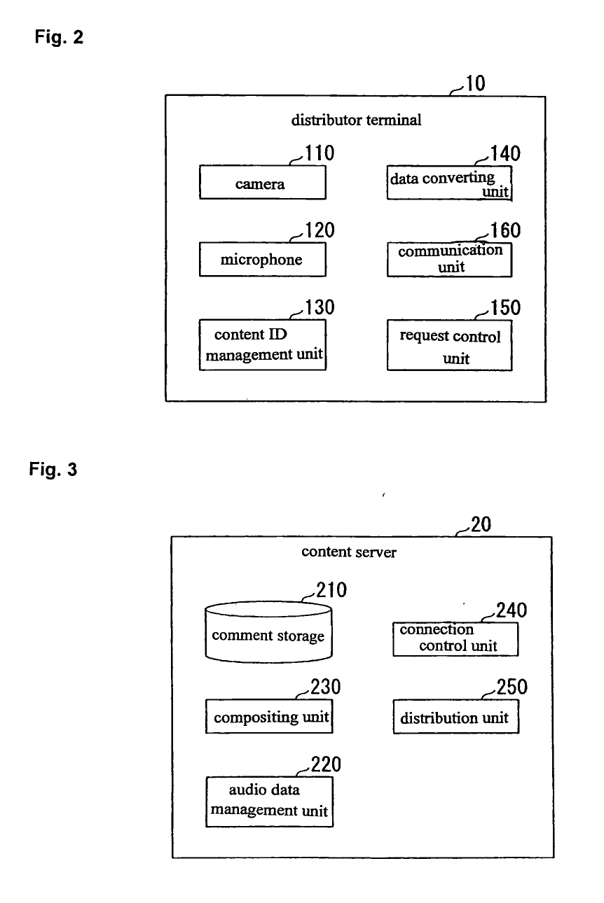

FIG. 2 is a block diagram showing the structure of the distributor terminal 10. The distributor terminal 10 is a terminal used by a distributor who distributes live pictures. The distributor can be any person who is performing in the content in live pictures such as a master of ceremonies, talent, an actor, an actress, or other performer.

In the distributor terminal 10, a camera 110 captures an image of a capturing target. For example, an image is taken in real time of a performer who performs in a live picture which becomes content. A microphone 120 collects audio in the location where the image is being taken. For example, the voice of a performer on location (inside a studio) is recorded.

A content ID management unit 130 generates a content ID for identifying the content which is distributed by the distributor terminal 10. Each program (content) can be identified by its content M.

A data converting unit 140 converts the image data which is captured and generated by the camera 110, audio data which is collected and generated by the microphone 120, and the content ID which is generated by the content ID management unit 130 into data format for transmission.

In response to an instruction from the distributor, a request control unit 150 starts and stops receipt of requests and performs communication with the request management server 60, and it transmits requests for information stored in a request list storage unit 614 and receives the information. In addition, it receives instructions to select any of the users from the distributor and transmits the user ID of the selected user to the request management server 60.

A communication unit 160 has the function of distributing the audio data and the image data after conversion by the data converting unit 140 to the content server 20 as content, and it has the function of communicating with the request management server 60 and the audio communication connection apparatus 50.

FIG. 3 is a block diagram showing the structure of the content server 20. In the content server, a comment storage unit 210 stores comments in the form of text information being associated with comment identification information which identifies comments sent from the user terminals 30. The comment storage unit 210 may have a different comment storage region (thread) for each content (each program). It may also have a plurality of threads for a single content.

An audio data management unit 220 receives audio information which was transmitted from the audio communication connection apparatus 50 and transmits it to the distributor terminal 10.

A compositing unit 230 generates composited content which composites the audio (voice) information which the audio data management unit 220 received from the audio communication connection apparatus 50 and the content including the images and audio distributed from the distributor terminal 10. A connection control unit 240 distributes the content of the program which was selected by a user of a user terminal 30 through a distribution unit 25. The connection control unit 240 receives comments which were transmitted from a user terminal 30 in response to the distributed content, and it stores the comments in a corresponding memory region (thread) of the comment storage unit 210. When audio information is composited with the content by the compositing unit 230, the connection control unit 240 distributes the composited content through the distribution unit (content distribution unit) 250. The connection control unit 240 also reads out comments from the storage area of the comment storage unit 210 related to a program (content) which a user terminal 30 is replaying, and it distributes the comments which were read out to a user terminal 30 through the distribution unit 250. The distribution unit 250 distributes content and comments to the user terminals 30. An example of a method of content distribution is streaming distribution.

A plurality of user terminals 30 can be connected to the content server 20. Each user terminal 30 has an output unit for outputting comments together with content containing audio and images. This output unit is, for example, a display device or a speaker. Each user terminal 30 also comprises an input device such as a keyboard or a mouse for inputting comments, and a communication unit for communicating with the content server 20.

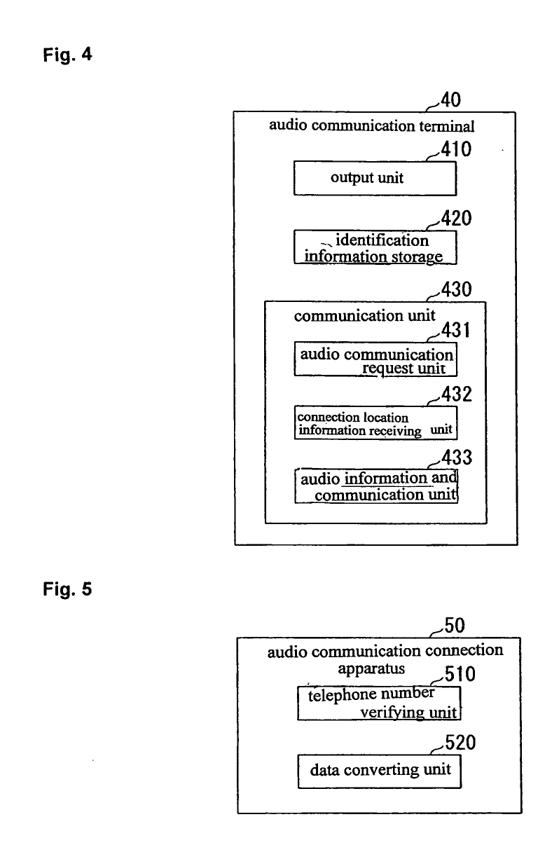

FIG. 4 is a block diagram showing the structure of the audio communication terminals 40. Each audio communication terminal 40 is, for example, a cellular phone, and it has the functions of picking up audio (the voice) of a user and transmitting it to a connection location, and receiving and outputting audio information as audio. An output unit 410 comprises a display device for displaying various information and a speaker for outputting audio.

An identification information storage unit 420 stores identification information which individually identifies the audio communication terminals 40. This identification information can be, for example, the telephone number of a cellular phone, and it can be any information used when calling the audio communication terminal 40. A communication unit 430 comprises an audio communication request unit 431, a connection location information receiving unit 432, and an audio information and communication unit 433. The communication unit 430 carries out various types of communication with other equipment.

The audio communication request unit 431 transmits an audio communication request to the request management server 60 in accordance with an instruction input from a user through an input unit and requests audio communication. This audio communication request is a request for audio communication with respect to distributed content by a user utilizing the audio communication terminal 40. The connection location information receiving unit 432 receives connection location information which is transmitted from the request management server 60.

The audio information and communication unit 433 connects the audio communication terminal 40 with the audio communication connection apparatus 50 in accordance with the connection location information received by the connection location information receiving unit 432 and transmits audio (voice) information. This audio information is audio spoken by a user of the audio communication terminal 40.

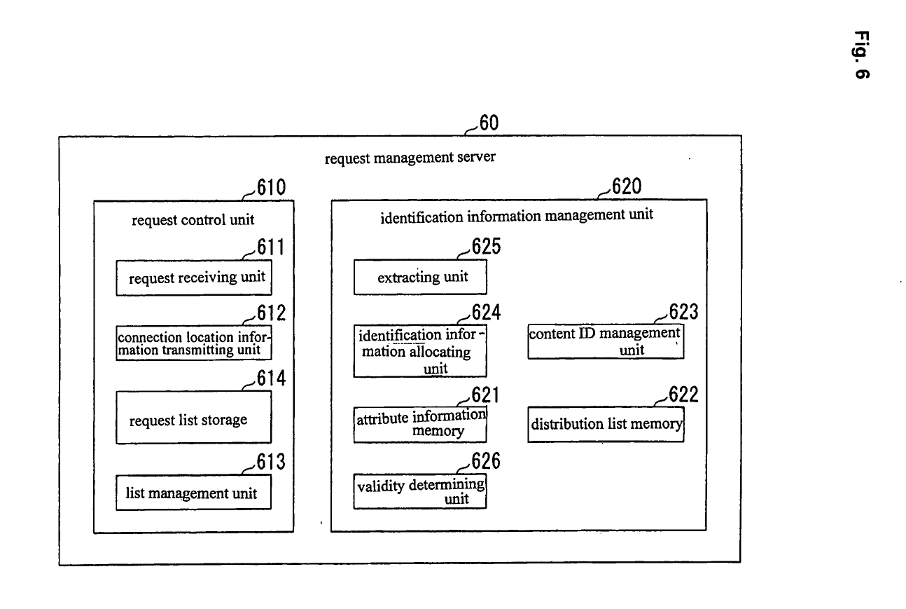

FIG. 5 is a block diagram showing the structure of the audio communication connection apparatus 50.

The audio communication connection apparatus 50 can be, for example, a PBX (private branch exchange) and has the function of connecting communication equipment to carry out audio communication. A telephone number verifying unit 510 reads out the telephone number of the transmitting source and the telephone number of the transmitting destination and outputs them to a validity determining unit 626 of the request management server 60 when a signal from the audio communication terminal 40 is received. The validity determining unit 626 determines whether these telephone numbers are valid. The telephone number verifying unit 510 then determines whether to establish communication with the audio communication terminal 40 in accordance with information from the validity determining unit 626 indicating validity or not. The telephone number verifying unit 510 establishes communication with the audio communication terminal 40 if it is notified by the validity determining unit 626 that the telephone number is valid, and if not, communication with the audio communication terminal 40 is cut off.

A data converting unit 520 extracts audio from the content distributed from the content server 20 and transmits it to the audio communication terminal 40 which originally transmitted it.

FIG. 6 is a block diagram showing the structure of the request management server 60.

The request management server 60 comprises a request control unit 610 and an identification information management unit 620. The request control unit 610 receives a request from an audio communication terminal 40 and notifies the audio communication terminal 40 of the extracted and selected user of its connection location information.

A request receiving unit 611 receives the audio communication request transmitted from the audio communication request unit 431 of the audio communication terminals 40. A connection location information transmitting unit 612 transmits to the audio communication terminal 40 extracted by an extracting unit 625 connection location information which indicates a different connection location for carrying out audio communication for each content. A request list storage unit 614 stores the user ID of the user who carried out a request being associated with selection identification information which indicates whether or not the user was extracted (selected) by the extracting unit 625. The user ID can be anything which individually identifies a user, such as the telephone number of the user or identification information which can uniquely specify the telephone number of the user. A list management unit 613 rewrites and updates the information which was stored in a request list storage unit 614 in accordance with a request from a user and the result of extraction by the extracting unit 625.

An identification information management unit 620 manages and allocates connection location information concerning which of a plurality of contents can be connected to, and when there is a connection request from an audio communication terminal 40, it determines whether connection may be carried out.

An attribute information memory 621 stores attribute information of each user who is utilizing an audio communication terminal 40. A distribution list memory 622 stores the ID of a user who carried out a request and the content ID which identifies the program (content) which was requested being associated with the telephone number allocated to the program (content) corresponding to the content ID. A content ID management unit 623 receives the content ID generated by the content ID management unit 130 of the distributor terminal 10 and writes it into the distribution list memory 622. An identification information allocating unit 624 allocates the telephone number of the distributor terminal 10 for participating in a program and stores the allocated telephone number in the distribution list memory 622 being associated with the content ID of the content of the program of interest. In carrying out this allocation, for example, the identification information allocating unit 624 stores a plurality of telephone numbers which can be utilized, and at the time of distribution of content, when it receives a content ID from the distributor terminal 10, it allocates any of the stored telephone numbers to the content ID. When the identification information allocating unit 624 is notified that a program (content) from the distributor terminal 10 has ended, of the information stored in the distribution list memory 622, it deletes the content ID of program (content) which has ended, the telephone number associated with the program (content), and the user ID from the top of the distribution list memory 622. The telephone number which was deleted from the distribution list memory 622 can be allocated to another program (content).

The extracting unit 625 extracts an audio communication terminal 40 to be connected from a plurality of audio communication terminals 40. There are a plurality of types of methods of extraction which can be carried out by the extracting unit 625, such as the following extraction methods (a)-(g)

(a) The telephone numbers of audio communication terminals 40 which support audio communication are previously stored, and extraction takes place from among these. Here, a request is not received. Instead, a user is made to previously indicate that he can communicate, and this indication is stored. For example, a user can previously register as a viewer of a program (content).

(b) Based on an audio communication request received by the request receiving unit 611, an audio communication terminal which is to be connected is extracted from the audio communication terminals 40 which made an audio communication request. Of the plurality of viewers who are watching the program (content), a user is extracted from among those who made a request.

(c) Based on the attribute information stored in the attribute information memory 621, an audio communication terminal 40 to which connection is to take place is extracted from audio communication terminals 40 corresponding to specified attribute information for a terminal to be connected. Specifying attributes of a user to be connected may be carried out by having the distributor terminal 10 specify attribute information to the request management server 60, or the request management server 60 itself may select from among the attribute information.

(d) An audio communication terminal which is to be connected may be randomly extracted from a plurality of audio communication terminals. In this case, either above-described (a) or (b) can be the object of connection, or both can be an object, and extraction can take place randomly from among them.

(e) Out of a plurality of audio communication terminals 40, audio communication terminals which are to be connected can be selected in the order in which an audio communication request was carried out. Namely, extraction is performed in the order of arrival of requests.

(f) Audio communication terminals 40 of users who have carried out a request or who have not carried out a request can receive a designation from the distributor terminal 10, and users who replied to this designation can be extracted. The distributor can arbitrarily carry out extraction.

(g) A plurality of audio communication terminals 40 can be extracted by above-described methods (a)-(f), and from the extracted audio communication terminals 40, audio communication terminals 40 which are to be connected can be extracted by any of methods (a)-(f).

In this manner, there are many extraction methods, but it is also possible to carry out extraction by combining a plurality of methods (a)-(g).

The validity determining unit 626 compares the telephone number of the sender detected by the telephone number verifying unit 510 and the telephone number of the recipient with information stored in the distribution list memory 622, and it determines whether the audio communication terminal 40 has carried out a valid outgoing call. This determination may be carried out by, for example, determining whether the telephone number of the transmission recipient is stored in the distribution list memory 622. If it is stored, an indication that it is valid is output to the telephone number verifying unit 510, and if it is not stored, an indication that it is invalid is output to the telephone number verifying unit 510.

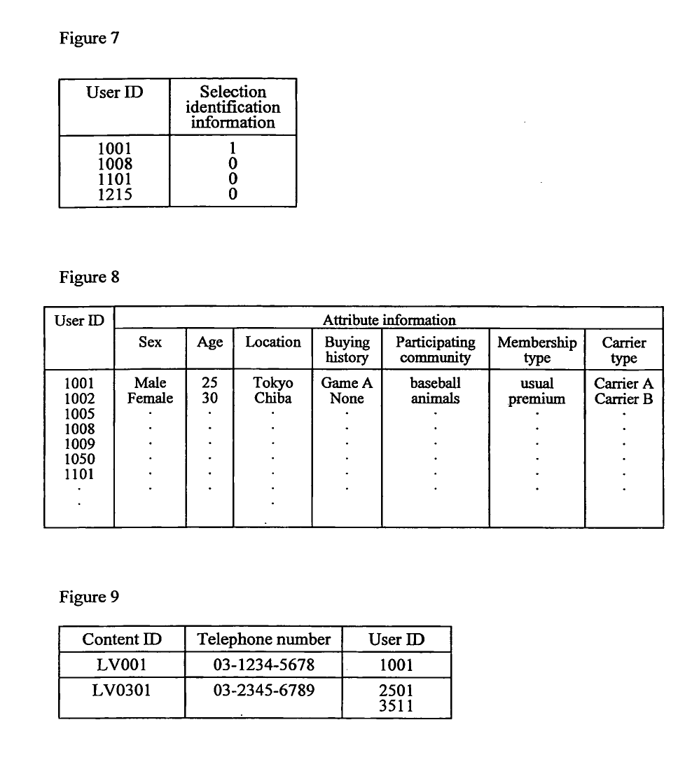

FIG. 7 is a diagram showing an example of information stored in the request list storage unit 614.

When the request control unit 610 receives a request from the audio communication terminal 40, the user ID of the user who sent this request is written in the request list storage unit 614 by the list management unit 613. The list management unit 613 writes a “0” which indicates that it is not selected at the stage upon writing the user ID as selected identification information, and when it is extracted by the extracting unit 625, it writes a “1” indicating selection associated with the user ID.

FIG. 8 is a figure showing an example of information stored in the attribute information memory 621. The user ID is information which identifies a user utilizing the audio communication terminal 40. It is stored in association with a user who registered using the communication system 1. The attribute information is stored information corresponding to the user ED and indicates attributes of the user. In this embodiment, the sex, the age, the location, the purchasing history, the participating community, the membership classification, and the carrier classification of the user are stored as the attribute information. The purchasing history is the history of articles purchased by the user at an interne shopping site associated with the communication system 1. The participating community indicates a community in which the user participates in the communication system 1. The membership classification indicates whether the user was a usual member at the time of membership registration in the communication system or whether he is a premium member receiving services with added value. The carrier information indicates the carrier of the audio communication terminal 40 (cellular phone) used by the user.

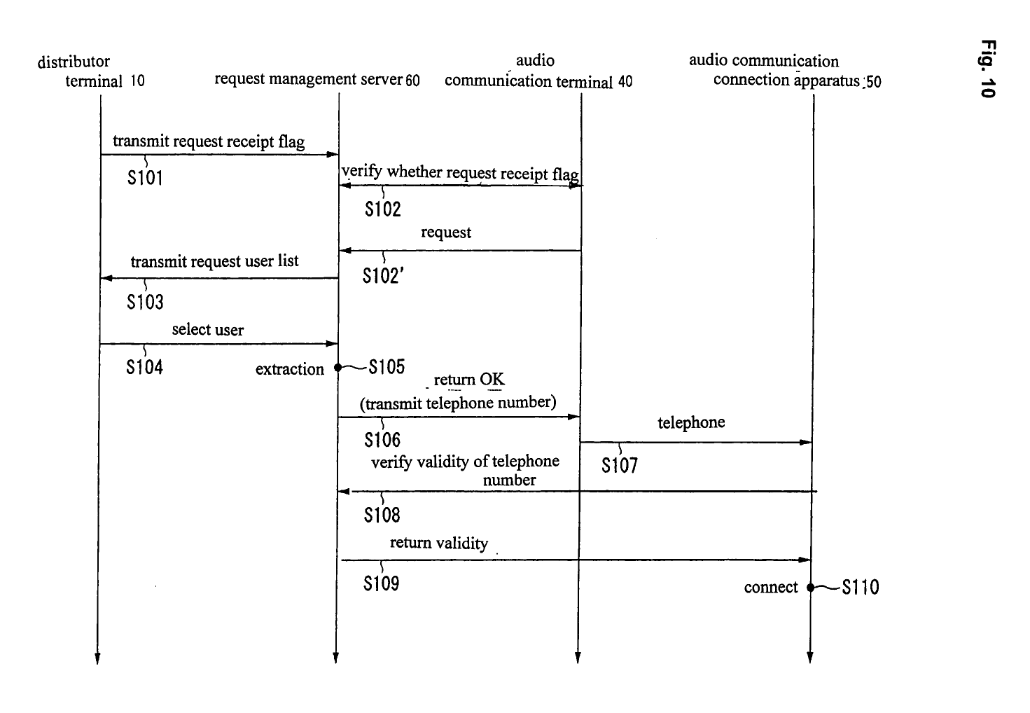

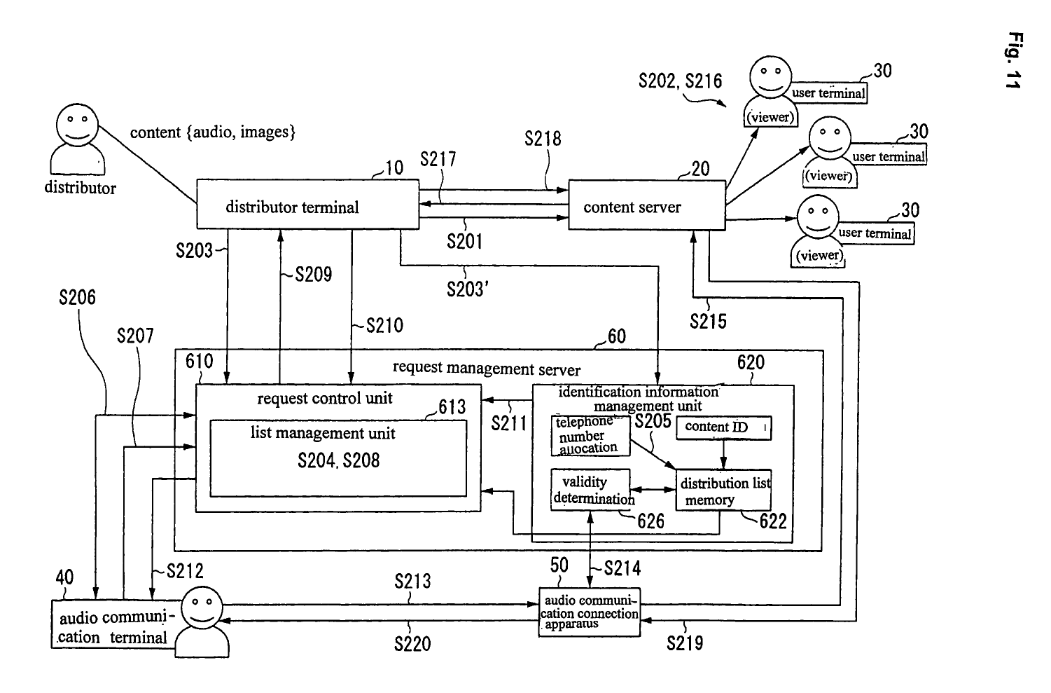

FIG. 9 is a figure showing an example of information stored in the distribution list memory 622.

The content ID is written by the content ID management unit 130. The telephone number is the telephone number allocated with respect to the content ID by the identification information allocating unit 624, and it is written in correspondence with the content ID by the identification information allocating unit 624. The user IDs of users who are participating in the live picture content, namely, the user IDs of users who are conversing with the distributor of the distributor terminal 10 by the audio communication terminals 40 are written. When a plurality of users are simultaneously participating in the same program, a plurality of user IDs are stored.

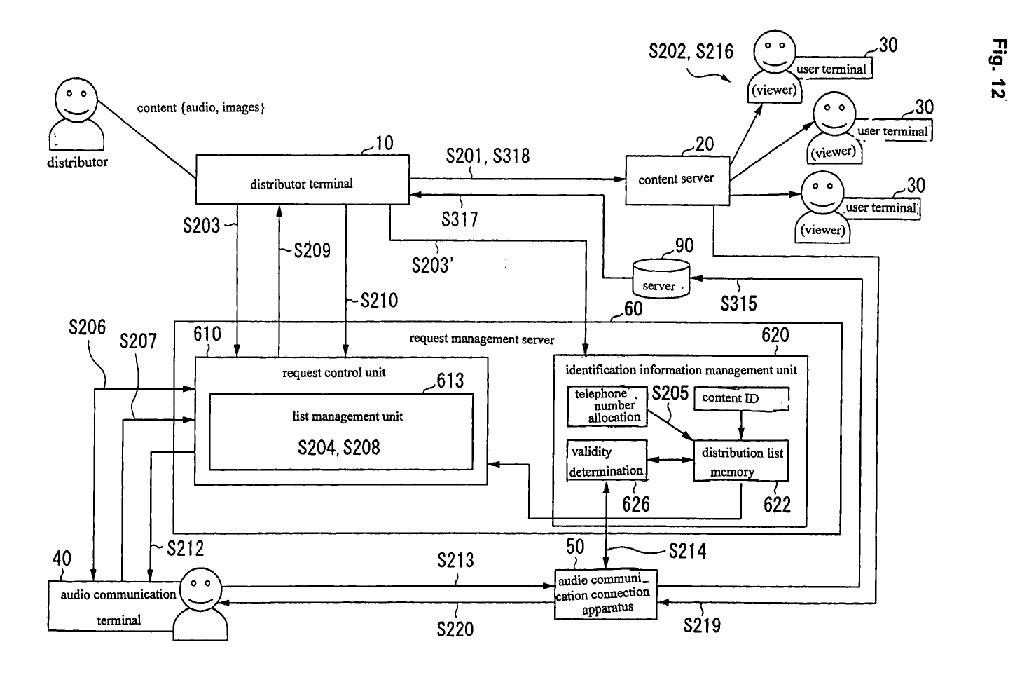

Referring to FIGS. 10 and 11, the operation of the above-described communication system 1 will be explained 1.

FIG. 10 is a sequence diagram showing the operation of the communication system. In FIG. 10, the operation of primarily the distributor terminal 10, the audio communication terminal 40, the audio communication connection apparatus 50, and the request management server 60 will be explained.

FIG. 11 is a figure showing the flow of information in the communication system.

First, the distributor terminal 10 distributes live pictures or audio data as content to the content server 20 (step S201 in FIG. 11) to start distribution of the program content. The content server 20 distributes the content which was distributed from the distributor terminal 10 to the user terminals 30 which designated the program (content) and requested watching (step S202 in FIG. 11). When a comment is transmitted from a user terminal 30, the content server 20 receives the comment and distributes the content to the other user terminals 30. As a result, moving pictures in the content are displayed on the display of the user terminals 30, and the comment is superimposed on the moving pictures. In addition, the audio corresponding to the audio data contained in the content is output from a speaker. This comment disappears from the images after a predetermined length of time has elapsed.

After the distributor terminal 10 distributes the content, when the timing for receiving a request has been reached, it transmits a request receipt flag indicating receipt of a request to the request control unit 610 of the request management server 60 (step S101 in FIG. 10 and step S203 in FIG. 11). In addition, the distributor terminal 10 transmits the content ID which was generated at the start of content distribution to the identification information management unit 620 of the request management server 60 (step S203′ in FIG. 11). When the list management unit 613 of the request management server 60 receives a request receipt flag from the distributor terminal 10 (step S204 in FIG. 11), it temporarily stores the content ID and the request receipt flag in predetermined memory area, and it reserves a memory area of the request list corresponding to this content ID in the request list storage unit 614. It also allocates the telephone number corresponding to the content ID, and it stores it in the distribution list memory 622 in correspondence with the content ID (step S205 in FIG. 11).

A user who is watching a program (content) with a user terminal 30 uses his own audio communication terminal 40 to confirm whether or not there is a request receipt flag by a polling function to the request management server 60 in order to determine whether the receipt of a request has commenced (step S102 in FIG. 10, step S206 in FIG. 11). When the list management unit 613 of the request management server 60 receives a request receipt flag, the request control unit 610 sends to the audio communication terminal 40 a flag indicating that a request is available with respect to the audio communication terminal 40, and when a request receipt flag has not been received, it sends to the audio communication terminal 40 a flag indicating that a request is not available.

When the audio communication terminal 40 receives transmission that a request is available and a command that a user has input a request, a request (audio communication request) is transmitted (step S102′ in FIG. 10, step S207 in FIG. 11).

When the request management server 60 receives a request, the user IDs of the requesting users are successively stored in the request list storage unit 614 (step S208 in FIG. 11). The request control unit 610 transmits a request list which was stored in the request list storage unit 614 to the distributor terminal 10 as a request user list (step S103 in FIG. 10, step S209 in FIG. 11). The distributor terminal 10 displays the received request list on a screen, and it transmits the user IDs which were selected from the list by the distributor to the request list management server 60 (step S104 in FIG. 10, step S210 in FIG. 11). When the request management server 60 receives the selected user IDs, it extracts users who are participating by audio in the program by the extracting unit 625 based on the received user IDs (step S105 in FIG. 10, step S211 in FIG. 11), and it transmits the telephone numbers which were allocated with respect to the program and the information indicating selection to the audio communication terminals 40 corresponding to the extracted user IDs (step S106 in FIG. 10, step S212 in FIG. 11).

When an audio communication terminal 40 receives the telephone number which is allocated to the program and notification of selection, it displays the telephone number and the notification of selection on its screen. When a user who sees the display inputs an instruction to send a dispatch to the displayed telephone number, the audio communication terminal 40 transmits the telephone number. As a result, a request to establish audio communication is transmitted from the audio communication terminal 40 to the audio communication connection apparatus 50 (step S107 in FIG. 10, step S213 in FIG. 11).

The audio communication connection apparatus 50 notifies the request management server 60 of the telephone number of the sender and makes an inquiry as to whether the telephone number of the sender is valid (whether it is recorded or not) (step S108 in FIG. 10, step S214 in FIG. 11).

When the request management server 60 receives an inquiry from the audio communication connection apparatus 50 as to whether the telephone number is valid or not, the validity determining unit 626 determines whether the telephone number is stored in the distribution list memory 622. If the telephone number is valid, notification that it is valid is transmitted to the audio communication connection apparatus 50 (step S109 in FIG. 10). If the audio communication connection apparatus 50 receives notification that it is valid, it permits audio communication by the audio communication terminal 40 to the transmitted telephone number (step S110 in FIG. 10). Namely, the audio communication connection apparatus 50 connects the audio communication terminal 40 and the content server 20 to forward audio (voice) information from the audio communication terminal 40 to the content server 20 (step S215 in FIG. 1).

When audio information is received from the audio communication terminal 40, the content server 20 composites the content and the audio information and distributes it to each user terminal 30 (step S216 in FIG. 11). As a result, a user can listen to the audio information from the audio communication terminal 40 together with the content.

The content server also transmits the audio information received from the audio communication terminal 40 to the distributor terminal 10 (step S217 in FIG. 11). As a result, the distributor of the distributor terminal 10 can listen to the audio information.

Next, when a distributor who has listened to the audio of the user from the audio communication terminal 40 starts talking, this audio is transmitted from the distributor terminal 10 to the content server 20 (step S218 in FIG. 11). The audio of the distributor is transmitted from the content server 20 to the audio communication connection apparatus 50 together with the content (step S219 in FIG. 11), and it is transmitted to the audio communication terminal 40 through the audio communication connection apparatus 50 (step S220 in FIG. 11). As a result, the user of the audio communication terminal 40 can listen to the speech of the distributor with respect to the content of his own speech, and he or she can have a conversation with the distributor.

In the above-described embodiment, the case was explained in which the content server 20 composites audio information from an audio communication terminal and content and transmits them to the user terminal 30. However, it is also possible to transmit audio which was transmitted from the audio communication terminal 40 to the user terminal 30 without the content server 20 compositing audio and content. Such a case will be explained below using the drawings.

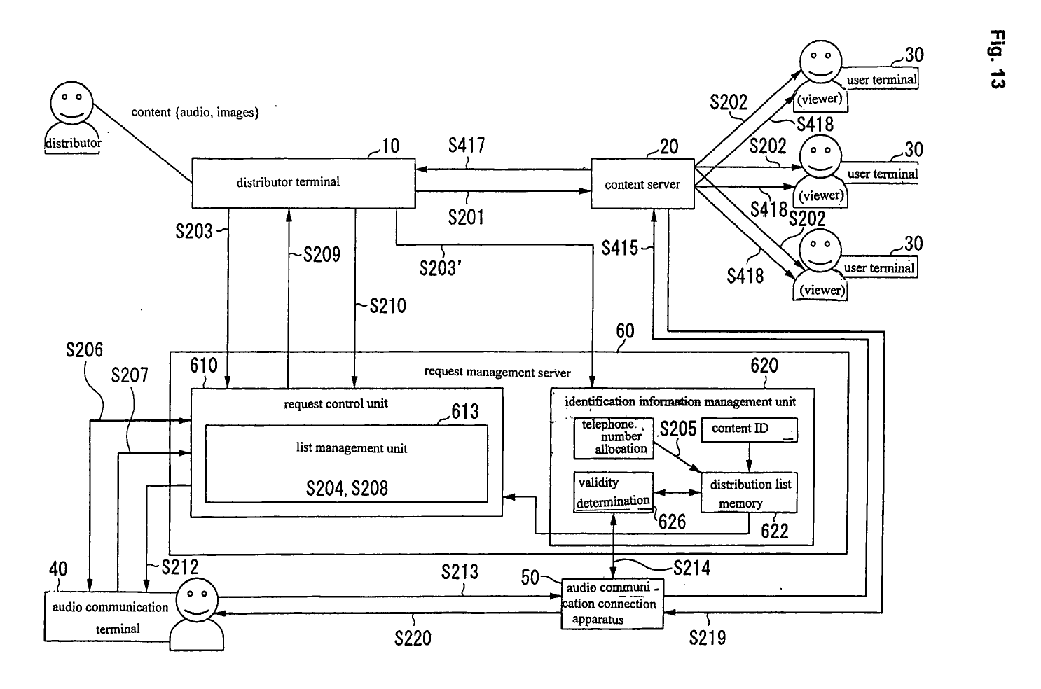

FIG. 12 is a block diagram for explaining the flow of information in a communication system 1 in a second embodiment.

The differences from the first embodiment are that a server 90 is provided in the communication system, and that the content server 20 does not receive audio information. Instead, the server 90 transmits audio information to the distributor terminal 10.

In this embodiment, when the audio communication connection apparatus 50 permits communication by the audio communication terminal 40, audio information from the audio communication terminal 40 is transmitted from the audio communication connection apparatus 50 to the server 90 (step S315). The server 90 transmits this audio information to the distributor terminal 10 (step S317). As a result, audio information from the audio communication terminal 40 is transmitted to the distributor terminal 10. This audio information is composited with content in the distributor terminal 10 and is distributed to the content server 20 (step S318). Next, this audio information is distributed from the content server 20 to the user terminals 30 as is (step S216).

FIG. 13 is a block diagram for explaining the structure of a communication system 1 in a third embodiment.

The differences from the first embodiment are that the content server 20 does not composite audio information and the content. Instead, when the content server 20 receives audio information from the audio communication connection apparatus 50 (step S415), the content server 20 transmits the audio information to the distributor terminal 10 (step S417) and also distributes it to each of the user terminals 30 (step S418).

In the above-described embodiments, the case was explained in which the audio communication connection apparatus 50 is a PBX, but it need not be a PBX as long as it can carry out audio communication. For example, it is possible to use a communication server which implements internet telephone service or the like by carrying out audio communication with a computer to which a headset is connected. In this case, the connection location information is not the telephone number but is identification information which identifies the person at the other end of the line.

In the above-described embodiments, the case was explained in which a comment storage unit 210 is provided in the content server 20, and comments and content are both distributed to the user terminals 30. However, a different server from the content server 20 may contain the comment storage unit 210 and provide the function of receiving comments from the user terminals 30 and the function of distributing comments stored in the comment storage unit 210 to the user terminals 30 as a comment server.

In the above-described embodiments, the case was explained in which the user terminals 30 and the audio communication terminals 40 are different devices, but they may be provided within the same device. If they are the same device, the function of watching moving picture content may be implemented by a cellular phone, for example. At this time, if a cellular phone is used both as a user terminal 30 and an audio communication terminal 40, when the user puts the cellular phone close to his ear to listen to the audio, he can no longer see the screen of his cellular phone. However, from the standpoint of communicating only while talking with the distributor by audio communication or from the standpoint of having a conversation with the distributor, it is possible to achieve communication.

The audio communication terminal 40 can be used in an outside location, so it is possible to easily participate in content even at an outside location. Namely, a request can be sent to the distributor terminal 10 from an audio communication terminal 40, a user can participate by voice during content distribution, and a user can talk with the distributor.

In this manner, even if a user has only an audio communication terminal 40 (a cellular phone), various types of communication can be achieved.

In the above-described embodiments, the case was explained in which content which is generated in real time is distributed from the distributor terminal 10 to the content server 20. However, the content which is distributed from the content server 20 is not limited to that generated in real time. For example, a distributor terminal may be provided which previously stores content in a memory apparatus such as a database, and the stored content may be distributed from the distributor terminal to the content server 20 as a program progresses. In this case, the distributor utilizes the microphone and speaker of the distributor terminal to carry out audio communication in real time with the audio communication terminals 40. For example, previously stored content is distributed from the distributor terminal to each user terminal 30 via the content server 20. The distributor and users of the audio communication terminals 40 can have a conversation by utilizing audio communication while viewing the distributed content, and this conversation can be distributed to each user terminal 30. As one example, a distributor and a user of an audio communication terminal 40 can have a conversation concerning the content of a baseball game while distributing a digest of the game as content, and this conversation can be distributed to each user terminal 30. In this case, because the distributor only needs to carry out audio communication while distributing the stored content, conversation may be carried out with users of audio communication terminals 40 by giving the distributor a portable terminal which can carry out audio communication and can be placed at a location different from the distributor terminal. As a result, even when a distributor such as talent is located far from a studio or the like where a distributor terminal is disposed, if the distributor carries an audio communication terminal, he or she can participate in the program from a remote location.

When distributing content which is generated in real time, a portion of the program can be distributed as previously stored content. For example, the opening and the ending of the program can be distributed as content generated in real time, and the remainder can be distributed as, for example, previously stored content.

In the above embodiments, the case was explained in which the request management server 60 performs extraction from among users who carried out a request based on the user IDs transmitted from the distributor terminal 10 in step S210 of FIG. 11. However, as described above, it is possible to perform extraction using attribute information.

Namely, the distributor terminal 10 may transmit one or more items of attribute information specified by the distributor to the request management server 60 and may carry out extraction of users based thereon. For example, if the attribute information that the location is Tokyo and the membership classification is premium is specified by the distributor, this attribute information is transmitted to the request management server 60, and users having attribute information matching this attribute information are extracted by the extracting unit 625. Here, the distributor may specify whether to extract users matching both of two categories or users who match either one, and the extracting unit 625 may extract users according to the specification.

In the above-described embodiments, the case was explained in which attribute information was used only when determining users who are to communicate with the distributor, but it is possible to use attribute information when determining the user terminals 30 to which content is to be distributed. For example, in step S210 of FIG. 11, instead of specifying the user IDs directly, the distributor terminal 10 specifies the attribute information which identifies the user terminal to distribute content and transmits it to the content server 20 as well as the request management server 60. For example, if the distributor specifies the attribute information that the location is Tokyo and the membership type is premium, this attribute information is transmitted to the request management server 60 and to the content server 20. If the content server 20 receives a request for content distribution from a user terminal 30, when it receives this attribute information together with this request, it accesses attribute information specified instead of user ID of the user terminal 30 which sent the transmission in the request management server 60 and it determines whether it matches the attribute information transmitted from the distributor terminal 10. As a result, the content server 20 distributes content to the user terminal 30 which matches the attribute information.

For example, the content is only distributed to a user who is a premium member, so that the user can browse content limited to premium member, or only users who are participating in the baseball community can be distributed limited content on an interview with a baseball player.

In the above-described embodiments, the categories which can be used as attribute information are not limited to the categories shown in FIG. 8, and it is possible to use information “only the user extracted by the extracting unit 625” as the attribute information, or it is possible to use a person who correctly answered a quiz concerning the content as attribute information. As a result, the content server 20 can distribute content to the user terminal corresponding to the attribute information which is the object of distribution of the content based on attribute information stored in the request management server 60. Accordingly, it is possible to determine content which can be viewed by attribute, and it is possible to limit distribution of content such that only users who satisfy certain conditions can view limited content.

Next, a fourth embodiment will be explained. In this embodiment, a user is selected from users who carried out a request, with selection taking priority into consideration.

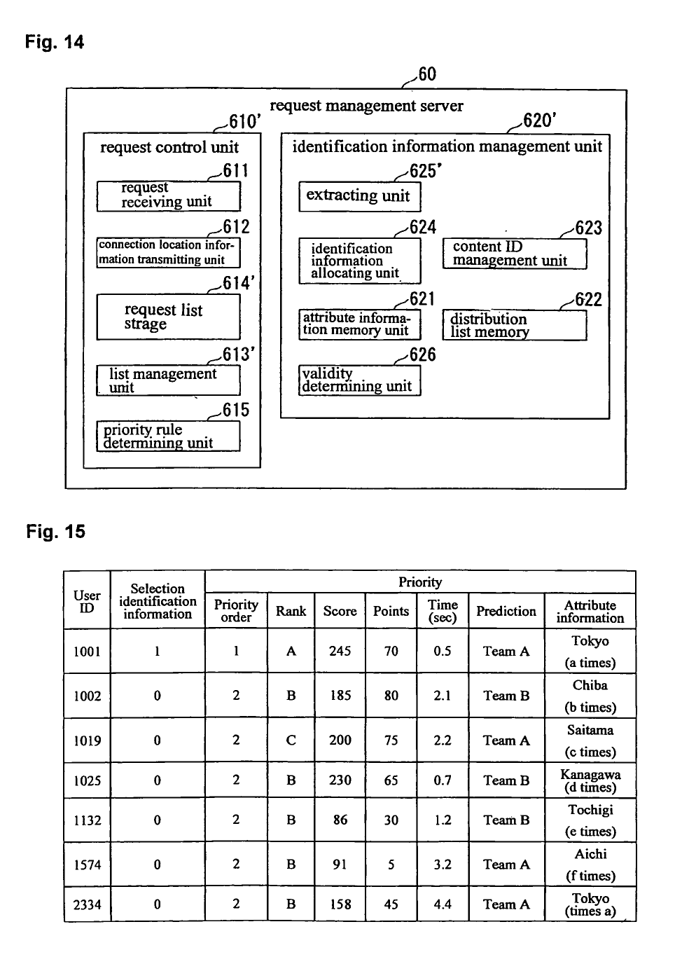

FIG. 14 is a figure showing the structure of a request management server 60′ in this embodiment. In this figure, units corresponding to units in FIG. 6 are identified by the same reference numbers, and an explanation thereof will be omitted. Below, functions which are different from in the above-described embodiments will be explained.

A request list storage unit 614′ associates user identification information which identifies users who are using the audio communication terminals 40 and a priority which indicates the priority of extraction and stores them. Here, the user identification information is information which individually identifies the user, such as the above-described user ID or the telephone number of the audio communication terminal 40.

The request list storage unit 614′ also stores new user identification information which is transmitted from the audio communication terminals 40 each time the request receiving unit 611 receives an audio communication request from the audio communication request unit 431.

An extracting unit 625′ extracts the audio communication terminal to be connected by extracting user identification information in accordance with the priority stored in the request list storage unit 614′.

When an instruction transmitted from at least one of the user terminals 30 and the audio communication terminals 40 is received or when the extracting unit 625′ performs extraction, a list management unit 613′ updates the priority stored in the request list storage unit 614′.

The list management unit 613′ receives an audio communication request, and when new user identification information is added to the request list storage unit 614′, it associates a priority related to the user identified by the user identification information with respect to the newly added user identification information and stores them in the request list storage unit 614′.

The priority rule determining unit 615 determines which item of priority to use, and it specifies to the list management unit 613′ as to the determined priority item to use as a rule. According to the specified priority item, the list management unit 613′ associates the specified priority item with each user ID stored in the request list storage unit 614′ in accordance with the rule and updates the priority corresponding to this priority item.

The priority item is information relevant for determining the priority such as the priority ranking, the rank, the score, the time, the prediction, and the attribute information. If a rule concerning which priority item to use for each content is previously determined, when the content to be distributed is determined, the priority item corresponding to this content is determined by the list management unit 613′, and the determined priority item is stored in association with the user ID in the request list storage unit 614′. For example, when distributing the content of a baseball game, it is possible to previously set a rule that the prediction is used as a priority item.

The rule may also be one which is determined in accordance with instructions from the distributor or listeners, and the priority item can be determined in accordance with instructions from the distributor or the listeners either before content distribution or during content distribution. For example, if content related to travel is being distributed, when the travel destination is Kanagawa Prefecture, a priority can be instructed by the distributor that the probability of selecting users located in Kanagawa Prefecture is ten times. In this case, for users for which the location in the attribute information is Kanagawa Prefecture, the item in attribute information of the priority is updated as ten times, and for users in other locations, it is updated as one time. Furthermore, when posing multiple quizzes related to a travel destination, if the distributor gives an instruction to use a score indicating the number of correct answers to the quiz as the priority, a user having a high score is preferentially selected. It is possible to set rules using multiple items. For example, when different users have the same score, a user having a higher priority of attribute information is selected by referring to the attribute information of the priority.

FIG. 15 is a figure showing an example of information stored in the request list storage unit 614′ in this embodiment. In this figure, the user ID, the selection identification information, and the priority are stored in the request list storage unit 614′ in association with each other. Some of the order of priority, the rank, the score, the points, the time, the prediction, and the attributes are stored as priority items. In the illustrated example, each priority item is stored, read out as the priority item to be used as a priority by the extracting unit 625′, and used at the time of extraction.

The “order of priority” is information indicating the order in which to prioritize extraction. The higher the order, the more preferentially extraction is performed. The “rank” indicates a rank given to each user. For example, there are ranks such as gold, silver, and bronze. The higher the rank, the more preferentially extraction takes place.

The “score” indicates the score obtained by a user in a predetermined game. The higher the score, the more preferentially extraction takes place. This game may be predetermined for each content. The game may be determined in accordance with an instruction which may be received from the distributor or a listener.

The “points” indicate the number of points bet by a user. For example, each user has his own points, when an instruction to bet points within the range of points owned by the user is input from the audio communication terminal 40 or the user terminal 30, the number of points stored in the request list storage unit 614 by the list management unit 613′ is incremented and updated.

The “time” is the time until a question is answered. For example, it can be the time until transmission of an answer to a quiz posed by the distributor during content distribution.

The “prediction” is the prediction of a user in response to a question. For example, with respect to the question “Who is going to win the game of team A versus team B”, the “prediction” is the answer of a user who predicts which team is going to win.

The “attribute information” is information showing the attributes of the user. For example, at least one item of the attribute information stored in the attribute information memory 621 is stored. Concerning which attribute to use as this attribute information, an item corresponding to what type of user to give preference is used. For example, the attribute may be predetermined for each content, or it may be determined in accordance with an instruction received from the distributor or a listener. Specifically, when using the location as the attribute information, a user located in Tokyo is given a selection probability of ten times, users in other locations are given a selection probability of one time, and users having a higher probability are preferentially extracted.

Next, the operation of this embodiment will be explained. Here, operation in which an audio communication request is received from an audio communication terminal 40 and the extracting unit 625′ carries out extraction, will be explained. Other operations are the same as in the above-described first through third embodiments, so an explanation of other operations will be omitted.

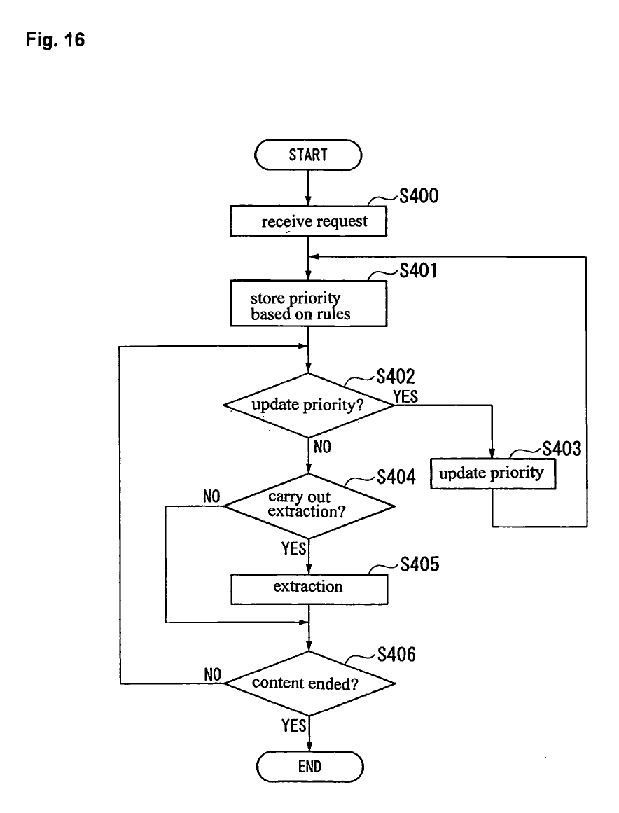

FIG. 16 is a flow chart for explaining the operation of the request management server 60.

When a request is sent from the audio communication terminal 40, the request management server 60 receives the request (step S400), it stores the request in the request list storage unit 614′, and it stores the priority in association with the user ID in accordance with the rule for determining to which priority to use. Here, in accordance with the rule, the priority item for the predetermined priority or information on the priority item of the priority instructed by the distributor (or a listener) is stored as an initial value in a reserved memory region (step S401).

When the priority item is determined, the list management unit 613′ determines whether or not to update the priority (step S402). In this updating, when the priority item has been changed or when the distributor (or a listener) has input an instruction to change the priority, it is determined that updating should take place, and updating is carried out (step S403). An example of the case in which the distributor (or a listener) inputs an instruction to change the priority is when the answers to a quiz are input or a prediction is input.

When it is determined not to update the priority, the extracting unit 625′ determines whether or not to carry out extraction (step S404). This extraction is carried out when the distributor or a listener inputs an instruction to carry out extraction, or when extraction timing which has been previously determined in accordance with the content is reached (such as at the completion of a baseball game). When extraction is carried out (step S405), the selection identification information of the selected user is updated to one and step S406 is proceeded to.

When it is determined not to carry out extraction, the list management unit 613′ determines whether or not distribution of content has ended (step S406), and when the distribution of content has ended, processing is ended. If the distribution of content is continuing, step S402 is proceeded to.

In the embodiments explained above, a priority is provided for each user, extraction is carried out in accordance with the priority, and a selection is determined. As a result, a new, more pleasurable communication space can be provided.

In this embodiment, after the extracting unit 625′ carries out extraction in accordance with the priority, when operation again moves to step S404, extraction can be again carried out from among users who have not yet been selected. Accordingly, instead of completing the process of receiving a request, carrying out extraction, and making an announcement, the requests which have already been received and the information on priority can be held, and the next extraction can be carried out using this data.

In this embodiment, the priority of users can be transmitted to the audio communication terminal 40 and displayed. For example, the priority information stored in the request list storage unit 614 can be read out, and the results which are read out can be transmitted by a request list controller 610′ to the audio communication terminal 40.

Here, information on the priority such as the order of priority of users who receive transmission, the score, or the like may be transmitted as is, or the order of users who carried out a request can be collected, and the collected result can be transmitted. For example, when transmitting the order of priority, when the information that “you are currently 15th” is displayed on the screen of the audio communication terminal 40 and the accumulated results of the score are transmitted, information which enables a user to see his difference from the top such as “the difference from the top is 80 points” is transmitted and displayed. When bingo is carried out as a game, information such as “there are 15 people who have declared bingo” is displayed. As a result, a user can see where he is positioned among users who carried out a request.

A program for implementing the functions of the distributor terminal 10, the content server 20, the audio communication terminal 40, the audio communication connection apparatus 50, and the request management server 60 in FIG. 1 can be stored in a computer-readable storage medium, the program which is stored on the storage medium can be read into a computer system, and the program can be executed to manage transmission and receipt of audio information. Here, a computer system also includes an operating system and hardware such as peripheral equipment.

When the computer system utilizes the World Wide Web, the computer system includes an environment providing a home page (or a browsing environment).

A computer-readable storage medium includes portable media such as floppy disks, magneto-optical disks, ROMs, and CD-ROMs, and storage apparatuses such as hard disks contained in a computer system. A computer-readable storage medium includes one which dynamically stores a program for a short period of time such as a communication line when transmitting a program through a network such as the internet or a communication circuit such as a telephone circuit, and it includes one which stores a program for a fixed length of time such as volatile memory inside a computer system which becomes a server or client in this case. The above-described program may implement a portion of the above-described functions, and it can execute the above-described functions together with a program which is already stored in a computer system.

In the above description, embodiments of the present invention have been described in detail while referring to the drawings, but a concrete structure is not limited to these embodiments, and it includes designs within the scope of the essence of the invention.

### INDUSTRIAL APPLICABILITY

The present invention can be applied to a communication system which distributes content from a distributor to users and in which users who are viewing the content can carry out communication with respect to the content, and users and the distributor can carry out various communications with respect to the content being distributed in real time.

### EXPLANATION OF SYMBOLS

1 communication system
10 distributor terminal
20 content server
30 user terminal
40 audio communication terminal
   50 audio communication connection apparatus
   60 request management server
   110 camera
   120 microphone
   130, 623 content ID management unit
   140 data converting unit
   150 request controller
   160, 430 communication unit
   210 comment storage unit
   220 audio data management unit
   230 compositing unit
   240 connection control unit
   250 distribution unit (content distribution unit)
   410′ output unit
   420 identification information storage unit
   431 audio communication request unit
   432 connection location information receiving unit
   433 audio information and communication unit
   510 telephone number verifying unit
   520 data converting unit
   610, 610′ request control unit
   611 request receiving unit
   612 connection location information transmitting unit
   613, 613′ list management unit
   614, 614′ request list storage unit
   615 priority rule determining unit
   620, 620′ identification information management unit
   621 attribute information memory
   622 distribution list memory
   624 identification information allocating unit
   625, 625′ extracting unit
   626 validity determining unit

1. A communication system for distributing content from a content distribution unit to a plurality of user terminals and distributing to the plurality of user terminals comments which are transmitted from the user terminals in response to the content which was transmitted to the user terminals, the communication system comprising:
a distributor terminal which distributes the content to the content distribution unit,
a plurality of audio communication terminals,
a request management server which comprises an extracting unit which extracts an audio communication terminal to which connection is to take place from the plurality of audio communication terminals and a connection location information transmitting unit which transmits connection location information which is different for each content to the audio communication terminal extracted by the extracting unit, and
an audio communication connection apparatus which is connected to the extracted audio communication terminal based on the connection location information transmitted from the extracted audio communication terminal and which makes communication possible between the extracted audio communication terminal, the content distribution unit, and the distributor terminal,
wherein the content distribution unit distributes audio information transmitted to the audio communication connection apparatus from the extracted audio communication terminal to the user terminals together with the content, and the audio communication connection apparatus transmits the audio information to the distributor terminal.

2. The communication system according to claim 1, wherein each of the audio communication terminals is a cellular phone, and the connection location information is the telephone number of the audio communication connection apparatus.

3. The communication system according to claim 1, wherein the distributor terminal distributes content which was generated in real time to the content distribution unit.

4. The communication system according to claim 1, wherein each audio communication terminal comprises an audio communication request unit which transmits to the request management server an audio communication request to carry out audio communication concerning the content,
the request management server comprises a request receiving unit which receives an audio communication request transmitted from the audio communication request unit, and
the extracting unit extracts an audio communication terminal to which connection is to take place from among the audio communication terminals which made an audio communication request based on the audio communication request received by the request receiving unit.

5. The communication system according to claim 1, wherein the request management server comprises a request list storage unit which associates user identification information which identifies users who are using the audio communication terminals with a priority which indicates the priority of extraction and stores them, and
the extracting unit extracts the audio communication terminal to be connected by extracting user identification information in accordance with the priority stored in the request list storage unit.

6. The communication system according to claim 5, wherein the request management server comprises a list management unit which updates the priority stored in the request list storage unit when an instruction is received from any of the user terminals or the audio communication terminals or when extraction is carried out by the extracting unit.

7. The communication system according to claim 6, wherein the request list storage unit newly stores user identification information transmitted from the audio communication terminal each time the request receiving unit receives the audio communication request transmitted from the audio communication receiving unit, and
the list management unit stores the priority corresponding to the user identified by the user identification information being associated with the newly stored user identification information in the request list storage unit.

8. The communication system according to claim 1, wherein the request management server comprises an attribute information storage unit which stores the attribute information for each of the users who are using the audio communication terminals, and
the extracting unit extracts the audio communication terminal to be connected based on the attribute information stored in the attribute information storage unit.

9. The communication system according to claim 8, wherein the content distribution unit distributes content to the user terminals corresponding to the attribute information to which content is to be distributed based on the attribute information which is stored in the request management server.

10. The communication system according to claim 1, wherein the extracting unit extracts an audio communication terminal to which connection is to take place at random from among the plurality of audio communication terminals.

11. The communication system according to claim 1, wherein the extracting unit extracts the audio communication terminal which is to be connected from among the plurality of audio communication terminals in accordance with the order in which an audio communication request was carried out.

12. The communication system according to claim 1, wherein the extracting unit extracts the audio communication terminal which is to be connected from among the extracted audio communication terminals.

13. A communication method in a communication system for distributing content from a content distributing unit to a plurality of user terminals and distributing to the plurality of user terminals comments which were transmitted from the user terminals in response to the content distributed to the user terminals, the communication method comprising:
distributing the content to the content distribution unit by a distributor terminal,
extracting an audio communication terminal to which connection is to take place from the plurality of audio communication terminals by an extracting unit of a request management server,
transmitting connection location information which is different for each content to the audio communication terminal extracted by the extracting unit by a connection location information transmitting unit of the request management server,
receiving the connection location information transmitted from the request management server by the extracted audio communication terminal,
connecting to an audio communication connection apparatus in accordance with the connection location information to transmit audio information by the extracted audio communication terminal,
distributing audio information transmitted to the audio communication connection apparatus from the extracted audio communication terminal to the user terminals together with the content by the content distribution unit, and
communicating the audio information between the audio communication terminal and the distributor terminal by the audio communication connection apparatus.
